(19) United States
(12) Patent Application Publication
(10) Pub. No.: US 2010/0100207 A1
(43) Pub. Date: Apr. 22, 2010

(54) METHOD FOR PLAYING AUDIO FILES USING PORTABLE ELECTRONIC DEVICES

(75) Inventor: SHIN-WEI LEE, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/429,284

(22) Filed: Apr. 24, 2009

(30) Foreign Application Priority Data
Oct. 17, 2008 (CN) 200810304969.2

(51) Int. Cl. G06F 17/00

(52) U.S. Cl. 700/94

(57) ABSTRACT

A method for playing audio files using portable electronic devices, comprising: providing a portable electronic device and a processor wirelessly communicating with the portable electronic device; building a list of audio files to be played; downloading the audio files according to the list and storing the audio files in the processor; selecting audio files in the list by the portable electronic device; and wirelessly sending the selected audio files to the portable electronic device to play.

### BACKGROUND

1. Technical Field

The present invention relates to a method for playing audio files using portable electronic devices, and particularly to a method for playing audio files using portable electronic devices capable of saving file storage capacity of the portable electronic devices.

2. Description of Related Art

Many portable electronic devices such as mobile phones or personal digital assistants (PDA) have the function of playing audio files, such that the users of the portable electronic devices can enjoy music anywhere and any time.

However, most portable electronic devices usually have not very much file storage capacity. Generally, a conventional portable electronic device can only store a small quantity of audio files. Therefore, choices of the music may be limited. If the user wants to enjoy more music, the file storage capacity of the portable electronic device needs to be increased, which may increase the volume, weight and cost of the portable electronic device.

Therefore, there is room for improvement within the art.

### BRIEF DESCRIPTION OF THE DRAWINGS

Many aspects of the present method for playing audio files using portable electronic devices can be better understood with reference to the following drawings. The components in the various drawings are not necessarily drawn to scale, the emphasis instead being placed upon clearly illustrating the principles of the present method for playing audio files using portable electronic devices. Moreover, in the drawings, like reference numerals designate corresponding parts throughout the figures.

FIG. 1 is a schematic diagram of a portable electronic device and a processor, which are used in the methods for playing music using portable electronic devices according to exemplary embodiments.

FIG. 2 is a flow chart of a method for playing audio files using portable electronic devices, according to a first exemplary embodiment.

FIG. 3 is a flow chart of a method for playing audio files using portable electronic devices, according to a second exemplary embodiment.

### DETAILED DESCRIPTION

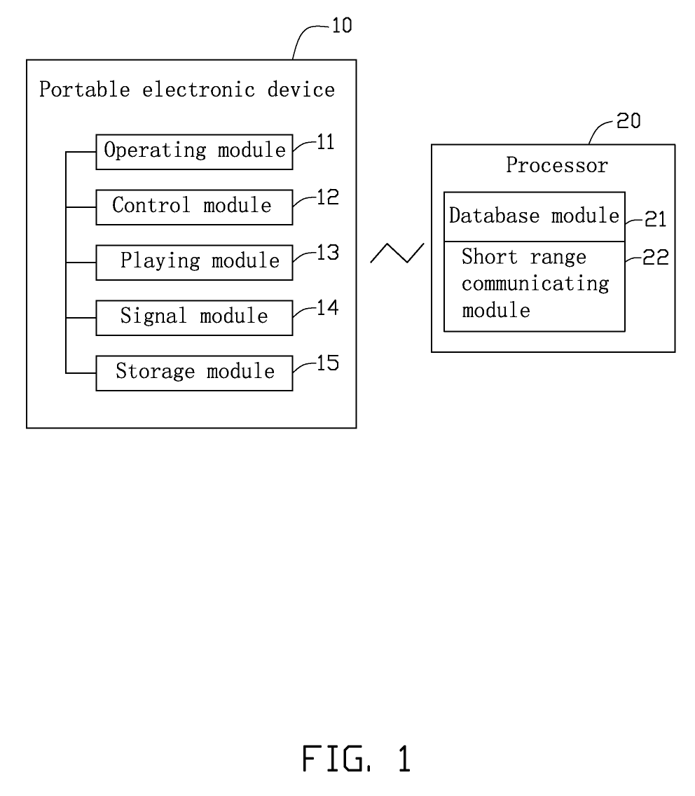

FIG. 1 schematically shows a portable electronic device 10 and a processor 20 used in methods for playing audio files using portable electronic devices according to exemplary embodiments. Using the methods according to exemplary embodiments, the portable electronic device 10 can cooperate with the processor 20 to play much audio files and needs not to increase its file storage capacity.

The portable electronic device 10 can be a typical mobile phone, personal digital assistant (PDA) or others, which has the function of storing and playing audio files. The portable electronic device 10 has an operating module 11, a control module 12, a playing module 13, a signal module 14 and a storage module 15, wherein the control module 12, the playing module 13, the signal module 14 and the storage module 15 are all electronically connected to the operating module 11.

The operating module 11 can include conventional operating apparatuses, such as keypads and displays, configured for user to operate the portable electronic device 10. The control module 12 can be an additional microprocessor installed in the portable electronic device 10 or a typical CPU of the portable electronic device 10, which is used to decode audio files and predetermine parameters associated with playing audio files using the portable electronic device 10, such as volume, tone, timing, etc. The playing module 13 is a typical audio playing apparatus, such as a speaker unit, configured for playing audio files. The signal module 14 is a wireless communication device, such as an antenna, a Bluetooth module, a Wi-Fi module, an infrared communicating module, etc., which is used to wirelessly communicate with the processor 20. The signal module 14 is electronically connected to the playing module 13. The storage module 15 is a buffer storage for storing audio files, which is connected to the control module 12, the playing module 13 and the signal module 14.

The processor 20 can be a typical personal computer or a special server for playing music. The processor 20 can be connected to communication networks such as internet or local area network (LAN) to download audio files, and can also wirelessly communicates with the portable electronic device 10 through communication networks such as internet, Wireless Application Protocol (WAP) etc. The processor 20 includes a database module 21 and a short range communicating module 22. The database module 21 can store audio signals. The short range communicating module 22 can be a Bluetooth module, a Wi-Fi module or an infrared communicating module, etc., which can wirelessly communicate with the signal module 14 of the portable electronic device 10 in a short range.

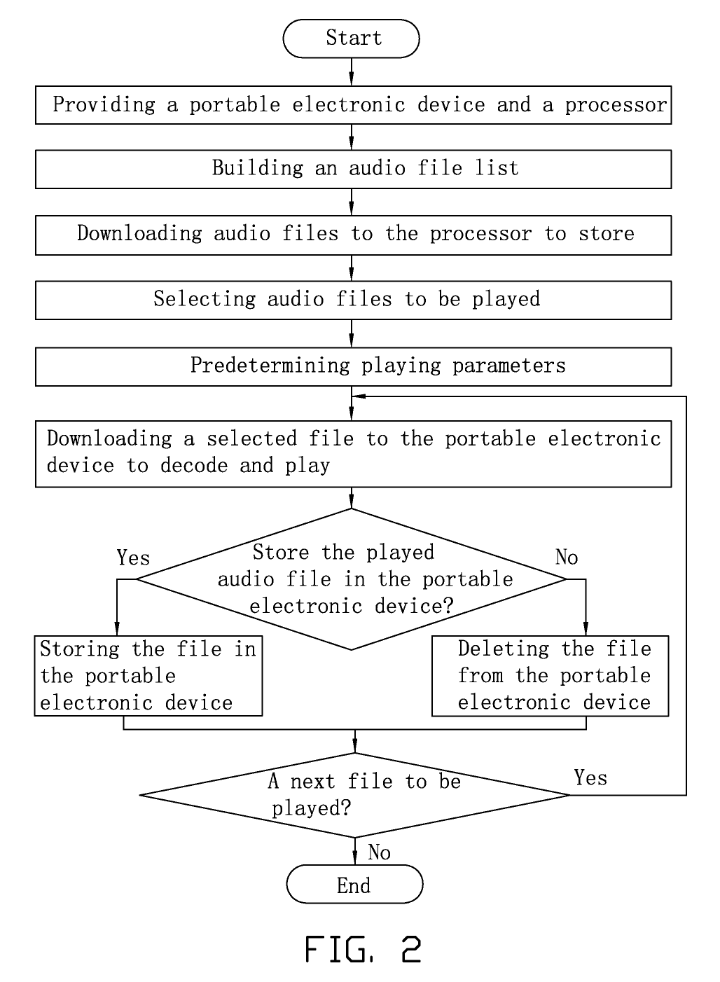

Also referring to FIG. 2, a method for playing audio files using portable electronic devices, according to a first exemplary embodiment, is provided. The method may include the following steps.

First, a portable electronic device 10 and a processor 20 are provided.

According to the music required to be played by the portable electronic device 10, a list of audio files is built and stored in the storage module 15 of the portable electronic device 10 and the database module 21 of the processor 20. The list of audio files can be edited by either of the portable electronic device 10 and the processor 20, and then sent to the other by USB interface or the aforementioned wireless communication methods.

The processor 20 downloads audio files from communication networks according to the list, and stores the audio files in the database module 21.

When the portable electronic device 10 is used to play music, the audio files to be played are selected from the list by the operating module 11. Playing parameters such as volume, tone and timing can be set by the control module 12.

After selecting played audio files and setting parameters, the portable electronic device 10 wirelessly downloads the first audio file in the list from the processor 20 through communication networks, such as internet or WAP. The audio file is received by the signal module 14 and temporarily stored in the storage module 15. When the audio file has been downloaded, the control module 12 decodes the audio file and the playing module 13 plays the audio file. When the downloaded audio file is played, a next audio file in the list is wirelessly downloaded and temporarily stored in the storage module 15 to be played. Downloaded and played audio files can be stored in the storage module 15 or automatically deleted from the storage module 15 according to set parameter options.

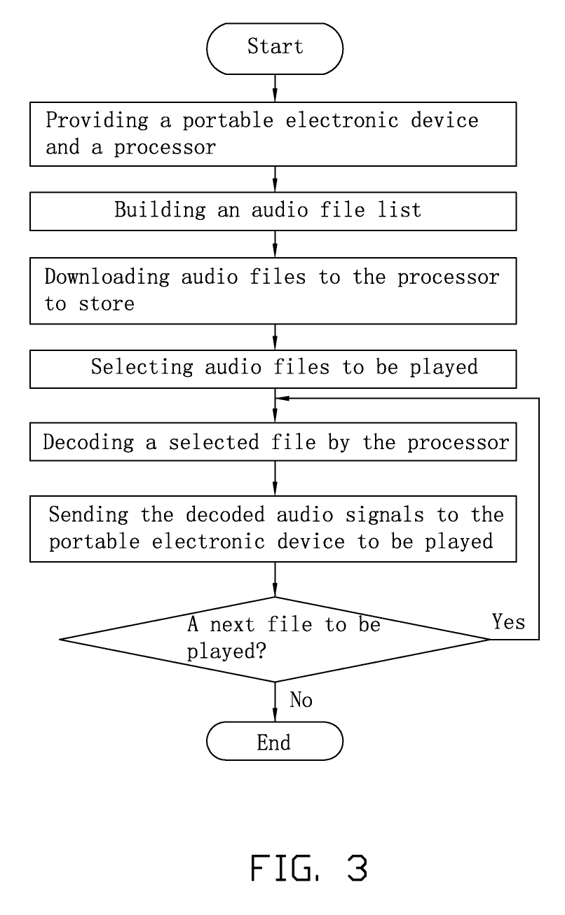

Also referring to FIG. 3, a method for playing audio files using portable electronic devices, according to a second exemplary embodiment, is provided. The method may include the following steps.

First, the portable electronic device 10 and the processor 20 are provided. The operations of building and storing the list of audio files to be played, downloading audio files and setting playing parameters are all similar to the first exemplary embodiment.

After selecting played audio files and setting playing parameters, the processor 20 decodes (i.e., can further play) the first audio file in the list. In the playing process, the decoded audio signals of the audio file are wirelessly sent to the portable electronic device 10 by the short range communicating module 22. The sending method can be Bluetooth communication, Wi-Fi communication or infrared communication, etc. The portable electronic device 10 receives the audio signals by the signal module 14 and plays the audio signals by the playing module 13, without the portable electronic device 10 having to store or decode the audio file. When the audio file has been played, a next audio file in the list is played by the processor 20 and wirelessly sent to the playing module 13 to be played. Thus, the portable electronic device 10 can play all audio files in the list, without downloading or storing audio files.

In the exemplary methods for playing audio files using portable electronic devices, the portable electronic device 10 can download and play a plurality of audio files one by one, or play the audio files played by the processor 20 without downloading. The played audio files are not required to be stored in the portable electronic device 10, instead, they are stored in the processor 20 having much more file storage capacity than the portable electronic device 10. The portable electronic device 10 does not require much additional file storage capacity to store audio files, thus volume, weight and cost of the portable electronic device 10 can all be decreased.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A method for playing audio files using portable electronic devices, comprising:
providing a portable electronic device;
providing a processor wirelessly communicating with the portable electronic device;
building a list of audio files to be played;
downloading the audio files according to the list and storing the audio files in the processor;
selecting audio files in the list by the portable electronic device; and
wirelessly sending the selected audio files to the portable electronic device to be played.

2. The method as claimed in claim 1, further comprising storing the list of audio files to be played in either of the portable electronic device or the processor.

3. The method as claimed in claim 2, wherein the list of audio files to be played is edited by the portable electronic device and then sent to the processor.

4. The method as claimed in claim 2, wherein the list of audio files to be played is edit by the processor and then sent to the portable electronic device.

5. The method as claimed in claim 1, further comprising setting playing parameters by the portable electronic device when selecting audio files in the list.

6. The method as claimed in claim 1, wherein the audio files is wirelessly sent to the portable electronic device by a method selected from the group consisting of Wireless Application Protocol, Bluetooth communication, Wi-Fi communication and infrared communication.

7. The method as claimed in claim 1, wherein the selected audio files are decoded and played by the portable electronic device.

8. The method as claimed in claim 1, wherein the selected audio files are decoded by the processor and played by the portable electronic device.

9. A method for playing audio files using portable electronic devices, comprising:
providing a portable electronic device;
providing a processor wirelessly communicating with the portable electronic device;
downloading the audio files to be played and storing the audio files in the processor;
wirelessly sending the audio files to the portable electronic device; and
decoding and playing the audio files by the portable electronic device.

10. The method as claimed in claim 9, further comprising building a list of audio files to be played by either of the portable electronic device or the processor and downloading audio files according to the list.

11. The method as claimed in claim 10, further comprising storing the list of audio files to be played in either of the portable electronic device or the processor and selecting audio files to be played from the list.

12. The method as claimed in claim 9, further comprising wirelessly sending an audio file to the portable electronic device to be temporarily stored therein before playing the audio file.

13. The method as claimed in claim 12, further comprising storing the temporarily stored audio file in the portable electronic device after playing the audio file.

14. The method as claimed in claim 12, further comprising deleting the temporarily stored audio file from the portable electronic device after playing the audio file.

15. The method as claimed in claim 1, wherein the audio files are wirelessly sent to the portable electronic device by Wireless Application Protocol.

16. A method for playing audio files using portable electronic devices, comprising:
providing a portable electronic device;
providing a processor wirelessly communicating with the portable electronic device;
downloading the audio files to be played and storing the audio files in the processor;
decoding the audio files by the processor;
wirelessly sending the decoded audio signals of the audio files to the portable electronic device; and
playing the audio signals by the portable electronic device.

17. The method as claimed in claim 16, further comprising building a list of audio files to be played by either of the portable electronic device or the processor and downloading audio files according to the list.

18. The method as claimed in claim 17, further comprising storing the list of audio files to be played in either of the portable electronic device or the processor and selecting audio files to be played in the list.

19. The method as claimed in claim 16, wherein the audio files are wirelessly sent to the portable electronic device by a method selected from the group consisting of Bluetooth communication, Wi-Fi communication and infrared communication.
